(19) United States
(12) Patent Application Publication
(10) Pub. No.: US 2016/0092809 A1
(43) Pub. Date: Mar. 31, 2016

(54) Method And System For Mitigating The Risk Of A Wrongful Burial

(71) Applicant: BlindCheck, LLC, Greenville, SC (US)

(72) Inventors: William Jackson Buchanan, Simpsonville, SC (US); William Adam Taylor, Greenville, SC (US)

(73) Assignee: BlindCheck, LLC

(21) Appl. No.: 14/963,680

(22) Filed: Dec. 9, 2015

Related U.S. Application Data
(63) Continuation of application No. 13/972,267, filed on Aug. 21, 2013, now abandoned.

(51) Int. Cl. G06Q 10/06; G06Q 50/16

(52) U.S. Cl. CPC G06Q 10/0635; G06Q 50/163

(57) ABSTRACT

Methods and systems for managing cemetery operations are provided. More particularly, a method of the present disclosure can mitigate the risk of a wrongful burial at a cemetery by ensuring a blind check is performed by an eligible user. Specifically, the method can determine whether the user has access to a blind check module and can present a blind check module interface when it is determined that the user has access to the blind check module for a deceased's interment, entombment, or inurnment.

### PRIORITY CLAIM

The present application is a continuation application of application Ser. No. 13/972,267, filed on Aug. 21, 2013, the contents of which are incorporated herein fully by reference.

### FIELD

The present disclosure relates generally to a method and system for managing cemetery operations and mitigating the risk of a wrongful burial.

### BACKGROUND

The process for managing cemetery operations, including the interment, entombment, or inurnment of a deceased's body can involve many steps. For example, an employee of a cemetery can first receive certain information pertaining to a deceased person from a funeral home. Based on this information, the employee can determine whether or not property or properties at the particular cemetery are owned by or for the benefit of the deceased. If one or more properties at the cemetery are owned by or for the benefit of the deceased, the employee can locate the property or properties based on information obtained via cemetery records for the grave sites—e.g., grave site space location(s) identifying each property—and place a flag in the property or properties for identification purposes. After meeting with the deceased's next of kin or legal representative and presenting to them the available one or more properties, a selection of the specific grave site space location is determined. Next, the employee can fill out a work order form and send the form to a maintenance group. The form can instruct the maintenance group to, for example, prepare the location for the interment, entombment, or inurnment of the deceased.

Once the property has been prepared, the same or different employee can perform a “blind check” to ensure the correct property has been prepared for the interment, entombment, or inurnment of the deceased. The blind check consists of having a party, i.e., the same or different employee, locate the prepared property based on a general description of the area where the property is located. Then, on a piece of paper having a grid drawn or printed thereon, the party can write down certain information of one or more of the deceased buried within a certain proximity of the prepared lot, such as one or more of the deceased's names as well as any unique cemetery PIN markers located in the vicinity. The party can then return to an office where records are stored, determine the unique grave site space location of each space where the recorded deceased were buried, and based upon the information collected, determine the unique grave site space location of the prepared property. The determined grave site space location of the prepared property from the blind check can then be compared to the grave site space location determined prior to a work order form being created for the maintenance group to confirm that a match exists prior to moving forward with the interment.

However, certain problems exist with the above method. For example, there is no means for reducing the risk that the party performing the blind check has been exposed to the unique grave site space location of the deceased's property prior to performing the blind check. When the party performing the blind check has been pre-exposed to the unique grave site space location of the deceased's property, the effectiveness of the blind check process can be negatively affected. Similarly, the deceased's file containing the unique grave site space location is generally not kept from the party performing the blind check, therefore the risk of pre-exposing such party to the actual grave site space location prior to the party determining the grave site space location through the blind check process can be great. Accordingly, an improved process for managing cemetery operations would be beneficial. More specifically, a process and system for mitigating the risk of a wrongful burial of a deceased at a cemetery would be particularly beneficial.

### SUMMARY

Aspects and advantages of the invention will be set forth in part in the following description, or may be obvious from the description, or may be learned through practice of the invention.

In one exemplary aspect of the present disclosure, a computer-implemented method of mitigating the risk of a wrongful burial of a deceased is provided. The exemplary method including receiving with a computing device identifying information of a first user and receiving a user input from the first user. The user input received from the first user includes a grave site space location corresponding to a property, the property associated with the deceased. The exemplary method also includes receiving identifying information of a second user and determining whether the second user has access to a blind check module for this specific interment, entombment, or inurement based at least in part on whether the identifying information of the second user differs from the identifying information of the first user. Additionally, the exemplary method includes presenting a blind check module interface associated with the blind check module when it is determined that the second user has access to the blind check module for a specific interment, entombment, or inurement.

In an exemplary embodiment of the present disclosure, a computing device is provided, the computing device including a display device, one or more processors, and at least one tangible non-transitory computer-readable medium. The computer-readable medium stores instructions that when executed by the processor perform operations. The operations include receiving with a computing device identifying information of a first user and receiving a user input from the first user. The user input received from the first user includes a grave site space location corresponding to a property, the property associated with the deceased. The operations also include receiving identifying information of a second user and determining whether the second user has access to a blind check module for this specific interment, entombment, or inurement based on whether the identifying information of the second user differs from the identifying information of the first user. Additionally, the operations include presenting a blind check module interface associated with the blind check module when it is determined that the second user has access to the blind check module for a specific interment, entombment, or inurement.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a flow diagram of an exemplary method of mitigating the risk of a wrongful burial of a deceased according to an exemplary embodiment of the present disclosure;

FIG. 2 depicts a flow diagram of another exemplary method of mitigating the risk of a wrongful burial of a deceased according to an exemplary embodiment of the present disclosure;

FIG. 3 depicts a flow diagram of an exemplary method of completing a blind check according to an exemplary embodiment of the present disclosure;

FIG. 4 depicts an exemplary blind check module interface in accordance with an exemplary embodiment of present disclosure;

FIG. 5 depicts an exemplary blind check module interface in accordance with an exemplary embodiment of present disclosure having received certain information; and

FIG. 6 depicts an exemplary computer-based system according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

### Overview

Generally, the present disclosure is directed to a method and system for mitigating the risk of a wrongful burial of a deceased. More particularly, the present disclosure provides a computer-implemented method for mitigating the risk that a deceased will be interred, entombed, or inurned in the wrong property within a cemetery.

In one exemplary aspect, the method may include receiving with a computing device identifying information of a first user. The first user may be an employee of the cemetery and the identifying information may be a user name and password. The method may further include receiving from the first user certain information pertaining to a deceased who is to be interred, entombed, or inurned at the cemetery. Such information may include the full name and dates of birth and death of the deceased, the legal representative of the deceased, the next of kin, and any other relevant information. The computing device may create a digital file associated with the deceased to organize and store all the data pertaining to the deceased. Based on the information pertaining to the deceased, the first user may determine whether or not property is owned at the cemetery by or for the benefit of the deceased. If property is owned by or on behalf of the deceased at the cemetery (i.e., associated with the deceased), the method may include receiving from the first user the grave site space location of the property owned by deceased. The grave site space location may be an alpha-numeric code that may be used to locate the property associated with the deceased within the cemetery.

In another exemplary aspect, the method may include receiving a user input from the first user, or another user, indicating that the property associated with the deceased has been located and marked using a first marker. The method may further include recording the date, time, or both that the property was located and marked, and recording the user that located and marked the property.

In still another exemplary aspect, the method may include receiving a user input from the first user, or another user, indicating that the property associated with the deceased has been marked using a second marker. Additionally, the method may include receiving a user input from the first user, or another user, indicating that the property associated with the deceased has been presented to the legal representative, the next of kin, or both. A verification effective against the representative, the next of kin, or both that the property associated with the deceased and marked using the second marker has been presented to and approved by the legal representative, the next of kin, or both may be captured, received by the computing device, and recorded by the computing device in the digital file of the deceased. The property may be marked with the second marker after presenting the property to the legal representative or next of kin and prior to capturing the verification. The method may further include recording the date, time, or both that the verification was recorded and the property marked with the second marker, and recording the user that captured the verification and marked the property.

In yet another exemplary aspect, the method may include generating a work order and sending the work order to a maintenance group. The work order may instruct the maintenance group to locate the property associated with the deceased and prepare the property for the interment, entombment, or inurnment of the deceased.

In another exemplary embodiment, the method includes completing a blind check to ensure the correct property has been marked, prepared, or both. Completing the blind check may include receiving information pertaining to one or more verification properties located within a predetermined distance from the prepared property. The information is preferably received from a user who has not been exposed to the grave site space location of the property associated with the deceased. For example, the information may be received from a second user. The second user may be told the general area of the cemetery where the deceased's property is located and may locate the property by searching the described area for a property that is prepared for an interment, entombment, or inurnment.

Based on the information received from the second user pertaining to the one or more verification properties, the method may additionally include determining the grave site space location of the prepared property. The grave site space location may be determined based on the location of the prepared or marked property relative to the verification properties. If the grave site space location determined during the blind check is the same as the grave site space location received by the computing device from the first user, then there is sufficient assurance that the prepared or marked property is the property associated with the deceased, and that therefore no wrongful burial will take place.

As described below in greater detail, in one exemplary embodiment, the blind check may be facilitated by a blind check module and blind check module interface, accessed by the second user when it is determined that the second user has access to the blind check module for the deceased's interment, entombment, or inurnment. For example, the second user may collect information directly into a blind check module interface when the blind check module is accessed from, for instance, a handheld computing device, such as a tablet or smartphone. Alternatively, the second user may collect information and then transfer it into the blind check module using the blind check module interface.

The blind check module may access a verification property database to determine the grave site space location of the one or more verification properties. Additionally, or alternatively, the second user may manually look-up the grave space site location(s) of the verification properties in the records stored at the cemetery. In certain exemplary aspects, the second user may manually enter the grave site space locations, determined by searching the records, into the blind check module and the blind check module may store the manually entered grave site space locations in the verification property database to assist in developing the database. With the grave site space locations of the verification properties determined, the second user or the computing device may determine the grave site space location of the prepared property based on its relative position to the verification properties.

In another exemplary aspect, the method and system may include generating and providing alerts regarding, e.g., the progress of the blind check, as well as one or more reports by compiling data collected and received associated with one or more of the deceased interred, entombed, or inurned in the cemetery for a given period of time.

### Process for Mitigating the Risk of a Wrongful Burial

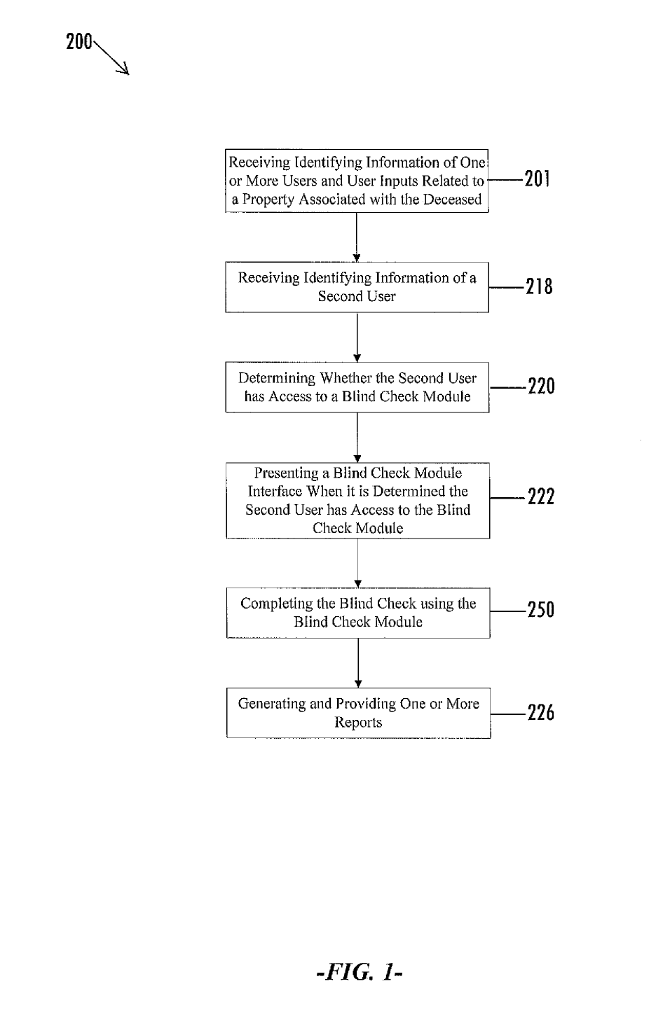

With reference now to the Figures, exemplary embodiments of the present disclosure will now be discussed in detail. FIG. 1 depicts a flow diagram of an exemplary computer-implemented method (200) of mitigating the risk of a wrongful burial of a deceased according to an exemplary embodiment of the present disclosure. The exemplary method (200) generally includes at (201) receiving identifying information of one or more users and user inputs related to a property associated with the deceased. The method (200) then includes at (218) receiving identifying information of a second user, and at (220) determining whether the second user has access to a blind check module for the specific deceased's interment, entombment, or inurnment.

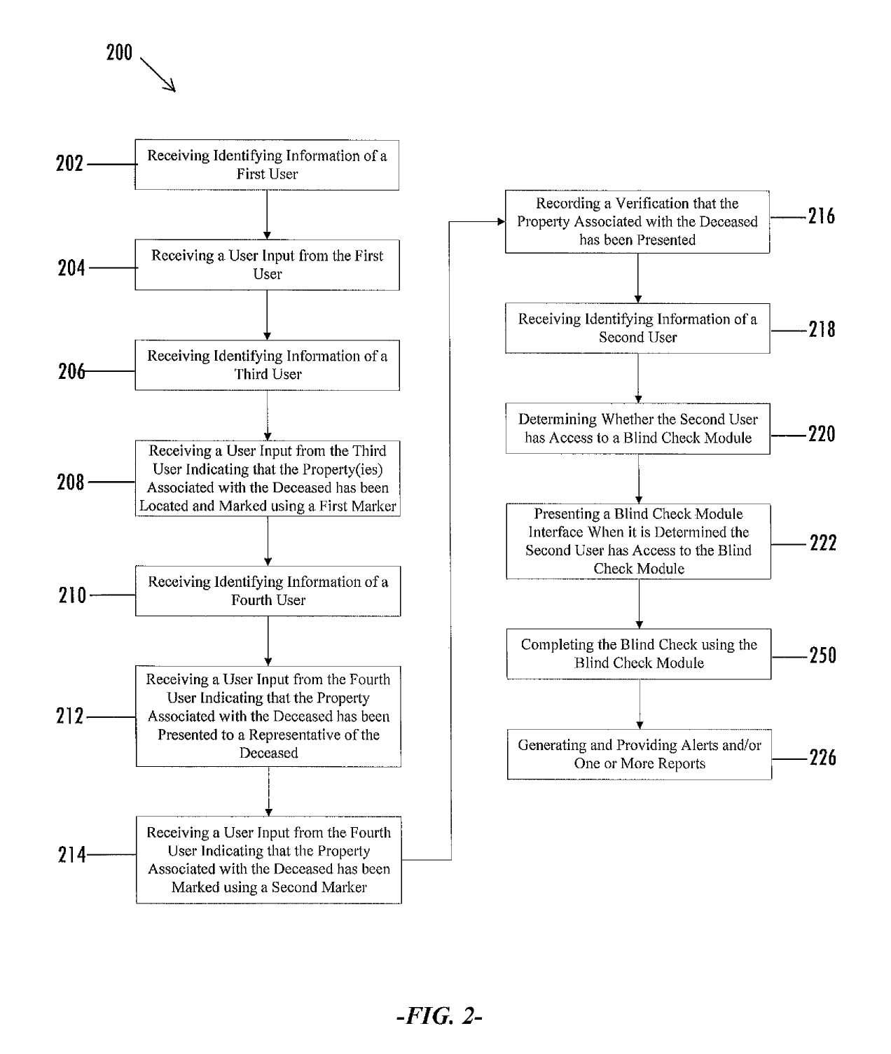

Another exemplary aspect of computer-implemented method (200) is shown in greater detail with reference to FIG. 2. The exemplary method (200) of FIG. 2 includes at (202) receiving with a computing device identifying information of a first user. The first user may be an employee at the cemetery where the method (200) is being executed, or any other person otherwise associated with the cemetery capable of performing the tasks described. For instance, the first user may be a Family Services Counselor employed by the cemetery. Additionally, the identifying information may be any suitable information to identify the first user. For example, the identifying information may be a user name, a password, a fingerprint, a retinal scan, or an identification card. The information may be received directly by the computing device, or may be communicated to the computer device using a peripheral device in communication with the computer device.

Once the identifying information of the first user has been received at (202), the exemplary method (200) includes at (204) receiving a user input from the first user. The user input may include one or more grave site space location(s) corresponding to one or more properties associated with the deceased. Notably, a new digital file for the deceased may also be opened prior to or along with receiving the user input from the first user. The computing device may require a user to input identifying information prior to accessing the deceased's digital file, and may record the identifying information of all users who have accessed the deceased's file along with the time and duration of the access.

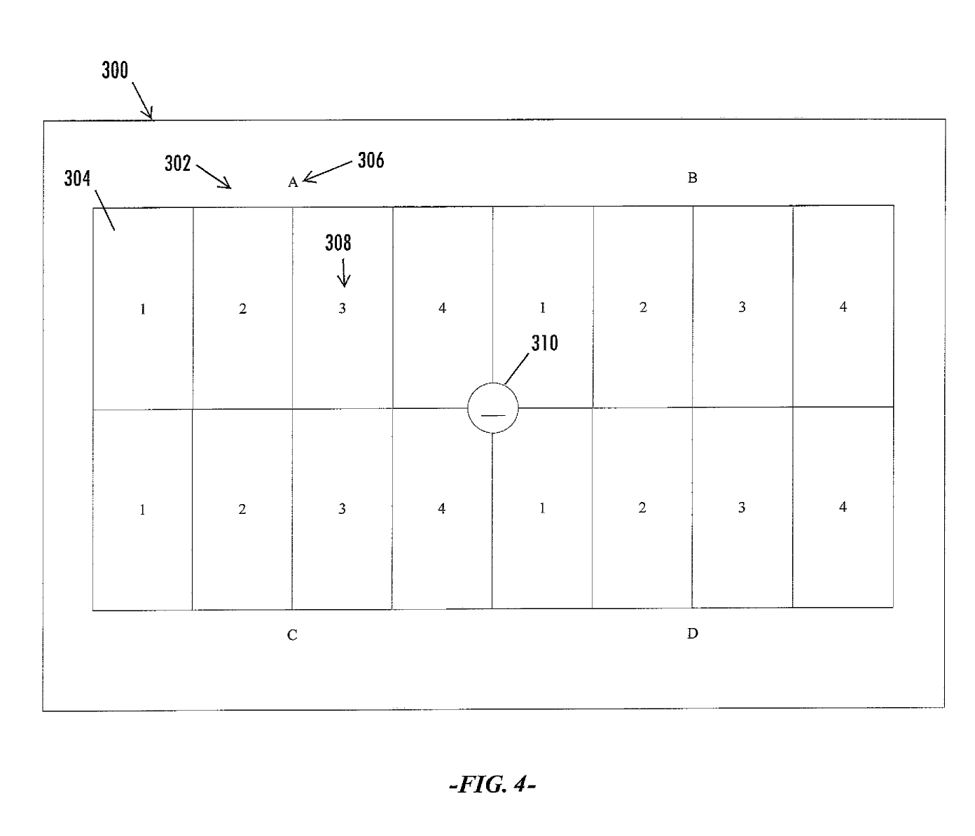

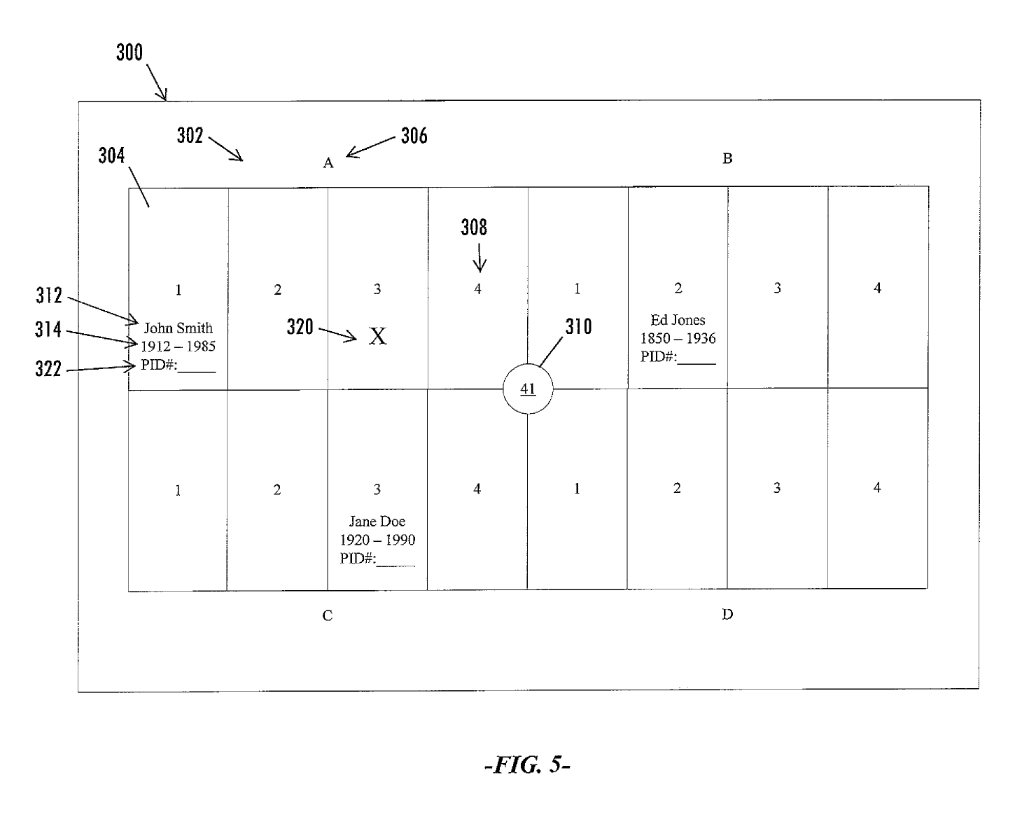

For example, in one exemplary aspect of the method (200) the first user may receive a call providing certain information regarding a deceased, such as the deceased's name, date of birth, date of death, etc. From this information, the first user may determine based on certain records at the cemetery whether or not one or more properties at the cemetery are owned by or for the benefit of the deceased. If one or more properties are owned by or for benefit of the deceased, the first user may input the grave site space location(s) of the property or properties associated with the deceased. As will be explained with reference to FIGS. 4 and 5, below, the grave site space location may be an alphanumeric code used to identify property within the cemetery.

The exemplary method (200) additionally includes at (206) receiving identifying information of a third user. As with the first user, the third user may be any person employed or otherwise associated with the cemetery capable of performing the tasks described, and the identifying information may be any information suitable to identify the third user. Additionally, the method (200) at (208) includes receiving a user input from the third user indicating that the one or more properties associated with the deceased have been located using the grave site space location and marked using a first marker. If multiple properties are associated with the deceased, then the first marker may actually be a plurality of markers. Additionally, the first marker may be any physical or electronic marker capable of distinguishing and/or assisting in the location of the property. For instance, the first marker may be a physical marker such as a flag, a design painted on the property, or an identifying object. Alternatively the marker may be an electronic marker, such as a Global Positioning System (GPS) chip. When the first marker is an electronic marker, the computing system may record identifying information of the marker in the electronic file of the deceased.

It should be appreciated, however, that in other exemplary aspects, no properties at the cemetery may be owned by or for the benefit of the deceased. In such is the case, the exemplary method (200) may include either the first or third user identifying one or more available properties within the cemetery, and the first or third user marking said available properties using a first marker.

Referring still to FIG. 2. at (210), the method (200) further includes receiving identifying information of a fourth user. Just as with the first and third users, the fourth user may be any person employed or otherwise associated with the cemetery capable of performing the tasks described, and the identifying information may be any information suitable to identify the fourth user. Additionally, at (212) the method (200) includes receiving a user input from the fourth user indicating that the one or more properties associated with the deceased (or available to the deceased should no property be owned for the benefit of the deceased) have been presented to a representative of the deceased. The representative of the deceased may include the deceased's next of kin, a legal representative of the deceased (such as an executor of the deceased's estate), or both. If multiple properties are available to or associated with the deceased, the representative may choose the desired property. Further, the method (200) includes at (214) receiving a user input from the fourth user indicating that the selected property has been marked using a second marker. As with the first marker, the second marker may be any suitable physical or electronic marker. The second marker may indicate that the representative has chosen a particular property from the one or more properties available to or associated with the deceased and/or confirmed the correct property is marked.

The method (200) at (216) then includes recording a verification effective against the representative of the deceased that the property marked using the second marker is the property associated with the deceased and has been chosen and/or confirmed by the representative as the property for the interment, entombment, or inurnment of the deceased. The verification may be any suitable verification to assist in proving that the property marked using the second marker and associated with the deceased was presented to the representative. For example, the verification may be a picture of the representative on or near the property associated with the deceased, a signed statement indicating that the property presented is the correct property, or any other suitable verification. The method (200) may include recording and storing the verification in the electronic file of the deceased, along with the date and time the verification was captured and the identification of the user who captured the verification.

It should be appreciated, however, that in alternative exemplary aspects of the present disclosure, the grave site space location of the property may be received by the third user or the fourth user. For example, general information regarding the deceased may be received by the first user. The third user may then lookup the grave site space location(s) of the property(ies) owned by or for the benefit of the deceased in files kept at the cemetery. Either prior or subsequent to marking the properties using a first marker, the method (200) may also include receiving the grave site space location(s) of the property(ies) associated with the deceased from the third user. Additionally, or alternatively, the method (200) may include receiving the grave site space location associated with the deceased from the fourth user after the representative has confirmed or picked out the property where they desire the deceased to be interred, entombed, or inurned.

It should also be appreciated that in other exemplary aspects of the present disclosure, the method (200) of the present disclosure may not include each of the steps above. Additionally, alterative exemplary aspects of the present disclosure may include the above steps in any other order. For example, (210) through (216) may be completed simultaneously with or prior to (206) through (208). It should also be appreciated that in other exemplary aspects, the third user, the fourth user, or both may be the same person as the first user, and/or the third user may be the same person as the fourth user. In such a case, the method (200) may not include (206) or (210).

In another exemplary aspect of the method (200), the method (200) may include generating a work order and sending the work order to a maintenance group. The computing device may generate the work order automatically, or in response to a user input. The work order may instruct the maintenance group to locate the property associated with the deceased and prepare the property for the interment, entombment, or inurnment of the deceased. For example, when the deceased is to be interred, the work order may instruct the maintenance group to dig an appropriately sized hole on the property. Alternatively, if the deceased is to be entombed or inurned the work order may instruct the maintenance group to prepare the burial site accordingly. The method (200) may further include receiving identifying information of the maintenance group and recording such information in the deceased's electronic file.

Referring still to the exemplary method (200) of FIG. 2, the method (200) includes at (218) receiving identifying information of a second user. As with the first user, the second user may be any person employed or otherwise associated with the cemetery capable of performing the tasks described, and the identifying information may be any information suitable to identify the second user. However, it is preferred that the second user is a user who has not been exposed to the grave site space location of the property associated with the deceased to ensure the effectiveness of the blind check. Accordingly, the exemplary method (200) additionally includes at (220) determining whether the second user has access to a blind check module for the deceased's interment, entombment, or inurement based on whether the identifying information of the second user differs from the identifying information of the first user. In addition, when as in the exemplary method (200) of FIG. 2 additional users have been exposed to the grave site space location of the property associated with the deceased, i.e., the third and fourth users and potentially the maintenance group, determining whether the user has access to the blind check module for the deceased's interment, entombment, or inurnment is further based on whether the identifying information of the second user differs from the identifying information of the additional users, i.e., the third and fourth users and potentially the maintenance group. Further, if additional users have accessed the digital file of the deceased, determining whether the second user has access to the blind check module for the deceased's interment, entombment, or inurnment may further be based on whether the identifying information of the second user differs from the identifying information of the additional users. Such a method can reduce the risk that the party performing the blind check has been exposed to the grave site space location of the property associated with the deceased prior to performing the blind check.

Notably, (220) may occur automatically in response to (218), or alternatively may occur in response to a user input received from the second user attempting to access the blind check module. Regardless, the method (200) further includes at (222) presenting a blind check module interface associated with the blind check module when it is determined that the second user has access to the blind check module for a deceased's interment, entombment, or inurnment. The blind check module interface may be presented on a display device in communication with computing device. The blind check module interface is discussed in greater detail, below, with reference to FIGS. 4 and 5.

In certain exemplary aspects of the present disclosure, the method (200) may include assigning the blind check to the second user automatically. The assigning of the blind check may include randomly choosing a user based on a pool of eligible users, or may include choosing a user based on one or more criteria, such as work load or performance history. Alternatively, the blind check may be assigned to the second user by an administrator, such as a manager or owner of the cemetery, chosen from pool of eligible users. In still other aspects of the method (200), the blind check may not be assigned to the second user. Instead, the computing device may send a notice to one or more eligible users that the blind check is ready to be performed, and the second user may volunteer to perform the blind check.

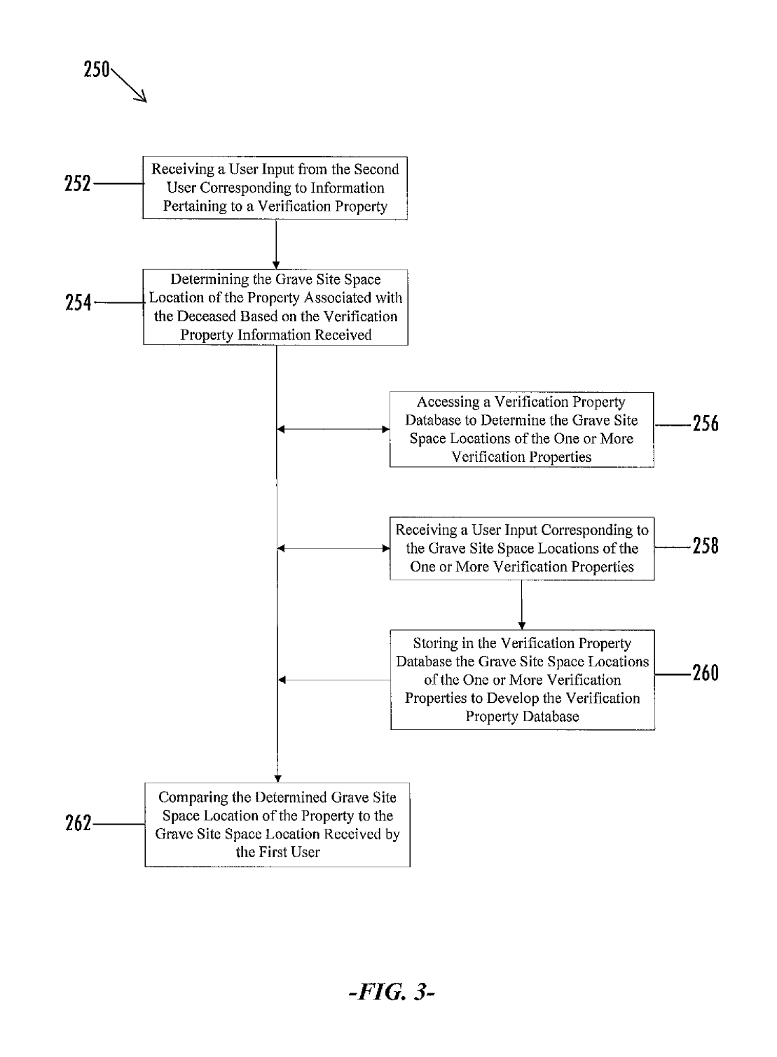

The exemplary method (200) further includes at (250) completing the blind check using the blind check module. Completing the blind check using the blind check module at (250) is shown in greater detail with reference to FIG. 3. FIG. 3 depicts a flow diagram of an exemplary method (250) for completing the blind check using the blind check module.

The exemplary method (250) of completing the blind check includes at (252) receiving a user input from the second user corresponding to information pertaining to one or more verification properties located within a predetermined distance of the property associated with the deceased. For example, the second user when accepting or being assigned the blind check may be given a general description of where the property is located. From the general description, and the knowledge that the property has been prepared by the maintenance group, the second user may locate the property associated with the deceased. The second user may then note certain information pertaining to one or more verification properties located within a predetermined distance of the property. The information may include the name of the deceased buried in the verification property, the date of birth, the date of death, unique cemetery PIN numbers near the property, maps and/or measurements from a specific point, or a combination thereof

In one exemplary aspect, (252) may be performed using a mobile or handheld computing device presenting the blind check module interface, allowing the second user to directly input the information pertaining to the verification properties. In alternative embodiments, the second user may record the information pertaining to the verification properties on, for example, a piece of paper.

The method (250) includes at (254) determining the grave site space location corresponding to the property associated with the deceased based on the information received pertaining to the one or more verification properties. For the exemplary method (250) of FIG. 3, determining at (254) includes at (256) accessing a verification property database to determine one or more grave site space locations associated with the one or more verification properties. This may be completed by the computing device automatically as information pertaining to the verification properties is entered, or subsequent to entering all the information. The verification property database, as will be discussed in greater detail below, may be any suitable electronic storage or memory device in communication with the one or more computing devices implementing the method (250). Alternatively, the verification property database may be an electronic storage or memory device included within one or more of the computing devices implementing the method (250).

Additionally, determining the grave site space locations at (254) includes at (258) receiving a user input corresponding to one or more grave site space locations associated with the one or more verification properties. The grave site space location may be looked up manually by the second user based on records kept by the cemetery. For example, the cemetery may keep records of all or some of the deceased that have been interred, entombed, or inumed in the cemetery. The records may be, for example, alphabetized by the deceased's last name or by section, lot, and/or burial cards. The grave site space locations may be received at (258) if, for example, the verification property database does not include one or more of the grave site space locations for one or more of the verification properties.

Referring still to the exemplary method (250), (250) additionally includes at (260) storing in the verification property database the one or more grave site space locations associated with the one or more verification properties received at (258) to develop the verification property database. This may help streamline future blind checks by building the verification property database automatically through the normal course of business.

It should be appreciated, however, that in other exemplary aspects of the present disclosure, the method (250) may not include accessing a verification property database at (256) or storing grave site space locations of verification properties at (260). In such an embodiment, the grave site space locations may be manually pulled for each verification property and entered into the blind check module interface.

Once the grave site space locations have been determined and/or added for the one or more verification properties, the grave site space location for the prepared property can be determined based on its position relative to the verification properties. This step may be done manually or by the computing device. Accordingly, the method (250) further includes at (262) comparing the grave site space location determined at (254) to the grave site space location received from the first user at (204) of the method (200) of FIG. 2. If the grave site space location determined at (254) matches the grave site space location received at (204), then there is sufficient assurance that the property prepared or marked using the first marker, the second marker, or both is the property associated with the deceased, and that therefore no wrongful burial will take place. Notably, in other exemplary aspects of the present disclosure, the grave site space location may be received from the third or fourth user. In such an exemplary aspect, (262) may instead include comparing the grave site space location determined at (254) to the grave site space location received by the third or fourth user.

Referring back to FIG. 2, the method (200) also includes at (226) generating and providing alerts and/or one or more reports. The alerts generated and provided at (226) may alert an administrator and/or the second user if, for example, the blind check has not been accepted and/or completed within a predetermined amount of time following the assignment of the blind check or prior to the scheduled interment, entombment, or inurnment. Such a method may ensure the blind check is timely completed prior to the interment, entombment, or inurnment of the deceased. For example, the alert may help ensure compliance with a cemetery's policy of completing the blind check at least twenty-four (24) hours prior to any interment, entombment, or inurnment of a deceased. In addition, the one or more reports may be compiled from data collected and received, and associated with one or more of the deceased interred, entombed, or inurned in the cemetery for a given period of time. The reports may, for example, automatically be generated after the completion of the blind check, or may be generated and provided automatically on a weekly, monthly, or quarterly basis. Alternatively, the reports may be generated and provided in response to a user input. In other exemplary aspects of the present disclosure, however, the method (200) may not include generating and providing reports at (226).

It should be appreciated, that as used herein, the terms “first user,” “second user,” “third user,” and “fourth user” and are used solely for the purposes of distinguishing people performing certain functions for a specific interment, entombment, or inurnment of an individual deceased. It should be appreciated, that for subsequent interments, entombments, or inurnments, different users may perform different functions.

### Blind Check Module and Blind Check Module User Interface

The blind check module interface may provide a user-intuitive means for inputting information pertaining to the one or more verification properties located within a predetermined distance of the property associated with the deceased. Further, as discussed above, the blind check module may provide for a streamlined process for determining the grave site space locations of the verification properties as well as the grave site space location of the property associated with the deceased based on the relative position of the property associated with the deceased to the verification properties.

An exemplary blind check module interface 300 is provided in FIG. 4. The blind check module interface 300 includes a grid 302 including a plurality of blocks 304. The grid 302 represents an area of the cemetery and is broken up into four (4) sections 306. Further, each section 306 includes individual blocks 304, each of which representing an individual property in that area of the cemetery. In the center of the grid 302, a pin 310 is represented which may define the area of the cemetery where the grid 302 is located. It should be appreciated, however, that in other exemplary embodiments, the grid may include any number of blocks 304 and in any suitable configuration. Additionally, in other exemplary embodiments, the pin 310 may be located in any suitable area of the grid 302, such as at any of the corners of the grid 302. The configuration of the grid 302 and pin 310 may depend on the particular layout of the properties within the cemetery. Additionally, alternative grids may be presented for mausoleum entombment or niche inurnment as well as any type of above or below ground final disposition arrangements used now or in the future.

As discussed, each property in the cemetery may be identified using a grave site space location. For the exemplary embodiment of FIG. 4, the grave site space location may be an alphanumeric code. The code may include reference to the number located on the pin 310, the section 306, and the block number 304. It should be appreciated, however, that in other exemplary embodiments, any other suitable numeric or alphanumeric code may be used.

Referring now to FIG. 5, an exemplary blind check module interface is provided, having the prepared property, or marked property, noted with an “X” 320 and information 312, 314, 322 pertaining to three verification properties received as well. Specifically, in the exemplary embodiment of FIG. 5, “John Smith” is buried two properties to the left of the deceased's property, “Ed Jones” is buried three properties to the right of the deceased's property, and “Jane Doe” is buried one property below the deceased's property. Accordingly, the blind check module interface may allow the second user to add the names 312 of the deceased buried in the verification properties as well as their dates of birth and death 314. The blocks 304 where no information is provided may correspond to vacant properties.

As discussed above with reference to FIGS. 1 through 3, after the information pertaining to the one or more verification properties has been received by the blind check module using the blind check module interface, the blind check module may access the verification property database to determine the grave site space location of the verification properties. Alternatively, the blind check module may do this as the information pertaining to the verification properties is being received. For example, if the grave site space location for John Smith was stored in the verification property database, the grave site space location may automatically populate a grave site space location field 322 in John Smith's block 304 after the relevant information was received. Additionally, if the grave site space locations for Ed Jones and Jane Doe were not stored in the verification property database, then the second user could pull the files for Ed Jones and Jane Doe to determine their grave site space locations, and manually enter them in their respective grave site space location fields 322 in their respective blocks 304. The blind check module may thereafter, or simultaneously, save the information pertaining to the verification properties and the corresponding grave site space locations to build the verification property database to help streamline the blind check process going forward.

Once the one or more verification properties and the corresponding grave site space locations have been received or pulled, the blind check module can determine the grave site space location of the prepared or marked property based on its relative position to the verification properties and compare it to the grave site space location of the property associated with the deceased received from the first user to verify that the appropriate property has been prepared or marked. This may be completed automatically as soon as a sufficient amount of information has been received. Further, the results may automatically be stored in the deceased's electronic file, reported to an administrator of the cemetery, and/or stored in the verification property database.

### Exemplary Computer Based System for Mitigating the Risk of a Wrongful Burial

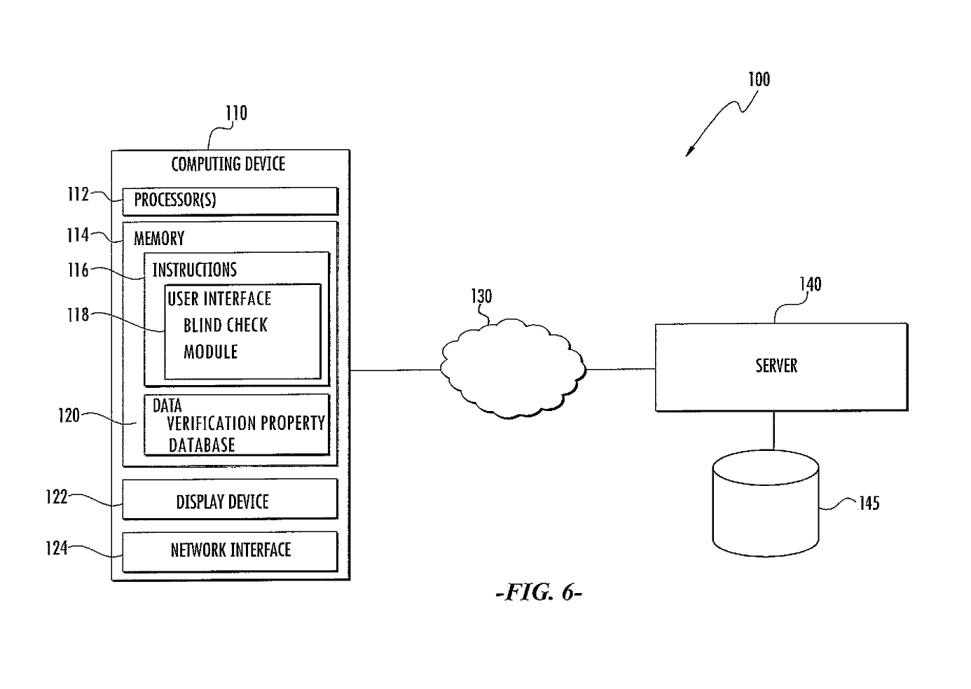

FIG. 6 depicts an exemplary computing system 100 that can be used to implement the systems and methods for minimizing the risk of a wrongful burial according to exemplary aspects of the present disclosure. The system 100 includes a computing device 110. The computing device 110 can include a general purpose computer, special purpose computer, laptop, desktop, smartphone, tablet, cell phone, mobile device, integrated circuit, or other suitable computing device. It should be appreciated, however, in other exemplary embodiments the computing device 110 can include a network of computing devices in wired or wireless communication with one another.

The computing device 110 can have a processor(s) 112 and a memory 114. The computing device 110 can also include a network interface 124 used to communicate with remote computing devices over a network 130. In one exemplary implementation, the computing device 110 can be in communication with a server 140, which can also be in communication with, for example, the verification property database.

The processor(s) 112 can be any suitable processing device, such as a microprocessor, microcontroller, integrated circuit, or other suitable processing device. The memory 114 can include any suitable computer-readable medium or media, including, but not limited to, RAM, ROM, hard drives, flash drives, magnetic or optical media, or other memory devices. The memory 114 can store information accessible by processor(s) 112, including instructions 116 that can be executed by processor(s) 112. The instructions 116 can be any set of instructions that when executed by the processor(s) 112, cause the processor(s) 112 to perform operations. For instance, the instructions 116 can be executed by the processor(s) 112 to implement the methods discussed above with reference to FIGS. 1 through 3, including the implementing the blind check module 118.

Memory 114 can also include data 120 that can be retrieved, manipulated, created, or stored by processor(s) 112. For instance, memory 114 can store verification property information, electronic files, etc. In one exemplary embodiment of the present disclosure, the verification property database may be stored in memory 114. In such an embodiment, the database 145 may act as a backup storage or auxiliary storage for the verification property database in memory 114.

It should be appreciated, that the term “module” as used herein, refers to computer logic utilized to provide desired functionality. Thus, a module can be implemented in hardware, application specific circuits, firmware and/or software controlling a general purpose processor. In one embodiment, the engines or modules are program code files stored on the computing device 110, loaded into a memory and executed by a processor, or can be provided from computer program products, for example computer executable instructions, that are stored in a tangible computer-readable storage medium such as RAM, hard disk or optical or magnetic media.

Computing device 110 can include or can be coupled to one or more input/output devices. Input devices may correspond to one or more peripheral devices configured to allow a user to interact with the computing device. One exemplary input device can be a touch interface (e.g. a touch screen or touchpad) that allows a user to interact with the exemplary user interface using touch commands. Output device can correspond to a device used to provide information to a user. One exemplary output device includes a display 122 of a handheld computing device, such as the display of a tablet computer. The computing device 110 can include or be coupled to other input/output devices, such as a keyboard, microphone, mouse, audio system, printer, and/or other suitable input/output devices.

The server 140 can host the system of the present disclosure. The server 140 can be configured to exchange data with the computing device 110 over the network 130. For instance, responsive to a request for information, the server 140 can encode data in one or more data files and provide the data files to the computing device 110 over the network 130. Similar to the computing device 110, the server 140 can include a processor(s) and a memory. The server 140 can also include or be in communication with one or more databases 145. Database(s) 145 can be connected to the server 140 by a high bandwidth LAN or WAN, or can also be connected to server 140 through network 130. The database 145 can be split up so that it is located in multiple locales.

The network 130 can be any type of communications network, such as a local area network (e.g. intranet), wide area network (e.g. Internet), or some combination thereof. The network 130 can also include a direct connection between a computing device 110 and the server 140. In general, communication between the server 140 and a computing device 110 can be carried via network interface 124 using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1.-20. (canceled)

21. A computer-implemented method of mitigating the risk of a wrongful burial of a deceased, the method comprising:
receiving, with a computing device, identifying information of a first user;
receiving a user input from the first user, the user input including a grave site space location corresponding to a property, the property associated with the deceased;
receiving identifying information of a second user;
determining whether the second user has access to a blind check module based at least in part on whether the identifying information of the second user differs from the identifying information of the first user; and
presenting a blind check module interface associated with the blind check module when it is determined that the second user has access to the blind check module and modifying a display of the blind check module interface based on the identifying information of the second user.

22. The method of claim 21, further comprising:
completing a blind check using the blind check module interface.

23. The method of claim 22, wherein completing the blind check using the blind check module comprises:
determining the grave site space location corresponding to the property associated with the deceased based on information pertaining to the one or more verification properties.

24. The method of claim 22, wherein completing the blind check using the blind check module comprises:
receiving a user input from the second user corresponding to a determined grave site space location; and
comparing the determined grave space site location to the grave site space location received from the first user.

25. The method of claim 22, wherein completing the blind check using the blind check module comprises:
receiving a user input from the second user corresponding to information pertaining to one or more verification properties located within a predetermined distance of the property associated with the deceased; and
determining the grave site space location corresponding to the property associated with the deceased by accessing a verification property database.

26. The method of claim 21, further comprising:
receiving identifying information of a third user; and
receiving a user input from the third user indicating that the property associated with the deceased has been located using the grave site space location received from the first user and marked using a first marker;
wherein determining whether the second user has access to the blind check module is further based on whether the identifying information of the second user differs from the identifying information of the third user.

27. The method of claim 26, further comprising:
receiving identifying information of a fourth user;
receiving a user input from the fourth user indicating that the property associated with the deceased has been presented to a representative of the deceased; and
recording a verification effective against the representative of the deceased that the property presented to representative is the property associated with the deceased;
wherein determining whether the second user has access to the blind check module is further based on whether the identifying information of the second user differs from the identifying information of the fourth user.

28. The method of claim 27, further comprising:
receiving a user input from the fourth user indicating that the property associated with the deceased has been marked using a second marker prior to recording the verification effective against the representative of the deceased.

29. The method of claim 27, wherein the third user is the same person as the first user, the fourth user is the same person as the first user, and/or the third user is the same person as the fourth user.

30. The method of claim 22, wherein the blind check module is completed using the blind check module interface presented on a mobile computing device.

31. The method of claim 21, wherein the identifying information of the first user, the identifying information of the second user, or both includes a user name, a password, a fingerprint, a retinal scan, or a combination thereof.

32. The method of claim 21, further comprising:
creating a digital file associated with the deceased; and
recording identifying information of all users who access the digital file of the deceased;
wherein determining whether the second user has access to the blind check module is further based on whether the identifying information of the second user differs from the identifying information of all the users who previously accessed the digital file of the deceased.

33. A computing device comprising a display device, one or more processors, and at least one tangible non-transitory computer-readable medium, the computer-readable medium storing instructions that when executed by the processor perform operations, the operations comprising:
receiving identifying information of a first user;
receiving a user input from the first user, the user input including a grave site space location corresponding to a property, the property associated with the deceased;
receiving identifying information of a second user;
determining whether the second user has access to a blind check module for the deceased's interment, entombment, or inurnment based on whether the identifying information of the second user differs from the identifying information of the first user; and
presenting a blind check module interface associated with the blind check module on the display device when it is determined that the second user has access to the blind check module for the deceased's interment, entombment, or inurnment, the presentation on the display device modified in response to receiving the identifying information of the second user.

34. The computing device of claim 33, wherein the operations further comprise:
receiving identifying information of a third user; and
receiving a user input from the third user indicating that the property associated with the deceased has been located using the grave site space location received from the first user and marked using a first marker;
wherein determining whether the second user has access to the blind check module for the deceased's interment, entombment, or inurnment is further based on whether the identifying information of the second user differs from the identifying information of the third user.

35. The computing device of claim 34, wherein the operations further comprise:
receiving identifying information of a fourth user;
receiving a user input from the fourth user indicating that the property associated with the deceased has been presented to a representative of the deceased; and
recording a verification effective against the representative of the deceased that the property presented to representative is the property associated with the deceased;
wherein determining whether the second user has access to the blind check module for the deceased's interment, entombment, and/or inurnment is further based on whether the identifying information of the second user differs from the identifying information of the fourth user.

36. The computing device of claim 35, wherein the operations further comprise:
receiving a user input from the fourth user indicating that the property associated with the deceased has been marked using a second marker prior to recording the verification effective against the representative of the deceased.

37. The computing device of claim 35, wherein the third user is the same person as the first user, the fourth user is the same person as the first user, and/or the third user is the same person as the fourth user.

38. The computing device of claim 33, wherein the identifying information of the first user, the identifying information of the second user, or both includes a user name, a password, a fingerprint, a retinal scan, or a combination thereof.

39. The computing device of claim 33, wherein the operations further comprise:
creating a digital file associated with the deceased; and
recording identifying information of all users who access the digital file of the deceased;
wherein determining whether the second user has access to the blind check module is further based on whether the identifying information of the second user differs from the identifying information of all the users who previously accessed the digital file of the deceased.

40. The computing device of claim 33, wherein the computing device comprises a plurality of computing devices in communication with one another.
